(19) United States
(12) Patent Application Publication
(10) Pub. No.: US 2009/0168891 A1
(43) Pub. Date: Jul. 2, 2009

(54) METHOD FOR CONTROLLING VIDEO ENCODING BIT RATE BASED ON TRANSPORT PACKET LENGTH, AND APPARATUS FOR CODING VIDEO USING THE SAME

(76) Inventors: Won-Sik Cheong, Daejeon (KR); Kyu-Heon Kim, Daejeon (KR); Young-Kwon Lim, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/720,647

(22) PCT Filed: Dec. 2, 2005
(86) PCT No.: PCT/KR05/04100

§ 371 Date: Jun. 1, 2007

(30) Foreign Application Priority Data
Dec. 3, 2004 (KR) 10-2004-0101405

(51) Int. Cl. H04N 11/02

(52) U.S. Cl. 375/240.23; 375/E07.026

(57) ABSTRACT

Provided is a video encoding rate controlling method based on the length of a Transport Stream (TS) packet in a video coding apparatus, the method including the steps of: a) setting up an initial target bit quantity for a picture to be coded; b) calculating a length of a payload used to packetize a coded picture into TS packets; c) adjusting the target bit quantity based on the length of the payload; and d) controlling a rate based on the adjusted target bit quantity in the step c).

### TECHNICAL FIELD

The present invention relates to a method for controlling a video encoding bit rate and an apparatus for coding a video using the same; and, more particularly, to a video encoding bit rate controlling method, which decreases a bit waste caused by a difference between a length of coded video bit stream and a length of a Transport Stream (TS) packet and increases a video coding efficiency by controlling a bit rate of a video coder based on the length of the TS packet, and a video coding apparatus using the same.

### BACKGROUND ART

FIG. 1 is a block diagram showing a conventional video coder.

As shown in FIG. 1, the conventional video coder transforms a difference image between an inputted actual image and a motion compensated prediction image obtained by a motion compensating block 109 into a frequency domain by using a transforming block 101. A transform coefficient is quantized in a quantizing block 102 and a variable length coding is performed on the transform coefficient by a variable length coding block 103.

Also, an image acquired through a decoding process using an inverse quantizing block 105 and an inverse transforming block 106, is stored in a frame memory 107 to estimate and compensate a motion by using a decoded image. Subsequently, motion estimation and compensation are performed in a motion estimating block 108 and a motion compensating block 109 by using the image stored in a frame memory.

Herein, the rate controlling block 104 controls a bit rate by observing a quantity of bits generated in the variable length coding block 103 and controlling a quantization step size of the quantizing block 102.

The quantizing block 102 quantizes transform coefficients and a quantization step size to be used in the quantization is determined by the rate controlling block 104. That is, the rate controlling block 104 observes the bit quantity coded until then and controls the generated total bit quantity to fit to an target bit quantity. Herein, when the quantity of the generated bit is smaller than the target bit quantity, the rate controlling block 104 increases the generated bit quantity by decreasing the size of the quantization step. When the generated bit quantity is larger than the target bit quantity, the bit rate controlling block 104 decreases the generated bits quantity by increasing the size of the quantization step. Controlling the bit rate is necessary for transporting a video through a transport channel with a limited bandwidth.

Conventionally, when the size of the quantization step is determined in the rate controlling block 104, the target bit quantity for each picture based on a transporting rate of a video stream is determined and the generated bit quantity based on the coding result is compared with the target bit quantity. When the generated bit quantity is larger than the target bit quantity, the size of the quantization step is increased. When the generated bit quantity is smaller than the target bit quantity, the size of the quantization step is decreased. Herein, when the size of the quantization step is determined, a complexity of a present picture is calculated. When the complexity of a picture coded in the present time is large, the rate controlling block 104 increases the size of the quantization step. When the complexity of a present picture is small, the rate controlling block 104 decreases the size of the quantization step. This method can be used with the above-described method together.

The coded video stream is transported after being formed into a transport stream based on a transport standard to correspond to a target. For example, when the coded video stream is transported after being formed into a transport stream based on a standard of MPEG-2 Systems, the video stream is first formed into a Packetized Elementary Stream (PES) packet. The PES packet is formed again into a Transport Stream (TS) packet and transported through a transport channel.

It can be schematically described as shown in FIG. 2. FIG. 2 is a diagram describing a transport packetization method of a video stream in a conventional MPEG-2 system.

As shown in FIG. 2, a video sequence 201 is coded as a video stream through a video coder 21 and made as a PES packet through a PES packetizer 22. Herein, the PES packet packetizes one access unit, which means that a smallest unit having time information, and one picture is included in one access unit since one time information is given to one picture in video coding.

Also, the number of bits generated by coding one picture depends on each picture. The PES packet includes a bit stream for one coded picture, i.e., the access unit, and a PES packet header. A length of the PES packets depends on each packet since the number of bits generated by coding one picture depends on each picture.

When a TS packetizer 23 forms the PES packetized video stream into the TS packet, one PES packet is formed into more than one TS packets. Herein, the TS packet includes a 4-byte header and a 184-byte payload, and the payload includes PES packet data, user private data and an adaptation field.

Meanwhile, when one PES packet is formed into more than one TS packet, the PES packet header should be positioned in the fore-front of the TS packet payload. That is, although there is a room in the TS packet after the PES packet is formed into the TS packet, it is not possible to put other PES packet data in the room. Therefore, the room of the TS packet is filled with stuffing bits, and it means a bit waste. In a worst case, when the length of the PES packet is 185 bytes, 184 bytes enter an initial TS packet and 1 byte enters a second TS packet. Also, since the 183 byte second TS packets are filled with stuffing bits, the 183 bytes are wasted.

In the conventional rate controlling method of the conventional video coder as described above, since the bit rate is controlled by setting up the target bit quantity used in coding of each picture based on the total bit quantity allocated to the video sequence, which is used for transport, and a length of the packet used for transport is not considered, an access unit length of the coded video bit stream becomes different from the length of the packet used for transport. Therefore, when the video sequence coded by the conventional rate controlling method packetizes the access unit, there is a problem that the bit waste is caused as much as difference between the length of the access unit and the length of the TS packet.

### DISCLOSURE

### Technical Problem

It is, therefore, an object of the present invention to provide a video encoding rate controlling method, which decreases a bit waste caused by a difference between a length of coded video bit stream and a length of a transport packet and increases an efficiency of video coding by controlling a rate of a video coder based on the length of a Transport Stream (TS) packet, and a video coding apparatus using the same.

### Technical Solution

In accordance with one aspect of the present invention, there is provided a video encoding rate controlling method based on a length of a Transport Stream (TS) packet in a video coding apparatus, including the steps of: a) setting up an initial target bit quantity for a picture to be coded; b) producing a length of a payload used to packetize a coded picture into the TS packet; c) adjusting the target bit quantity based on the length of the payload; and d) controlling a rate based on the adjusted target bit quantity in the step c).

In accordance with another aspect of the present invention, there is provided a video coding apparatus, including: a video coding block for transforming a difference between a present picture and a motion-compensated picture into a frequency domain, quantizing transform coefficient by control of a rate controlling block, performing a variable length coding on the transform coefficient and outputting the result into a video bit stream; and a rate controlling block for controlling the video coding block based on the length of the TS packet.

### ADVANTAGEOUS EFFECTS

The present invention can improve a video coding efficiency by using bits wasted in a formation of a Transport Stream (TS) packet for video coding again.

Also, since the present invention controls a rate based on a length of the TS packet of a coded video, the present invention can minimize a bit waste caused by packetization, thereby improving the quality of a coded video.

### DESCRIPTION OF DRAWINGS

The above and other targets and features of the present invention will become apparent from the following description of the preferred embodiments given in conjunction with the accompanying drawings, in which:

FIG. 1 is a block diagram showing a conventional video coder;

FIG. 2 is a diagram showing a transport packetization method of a video stream in a conventional MPEG-2 system;

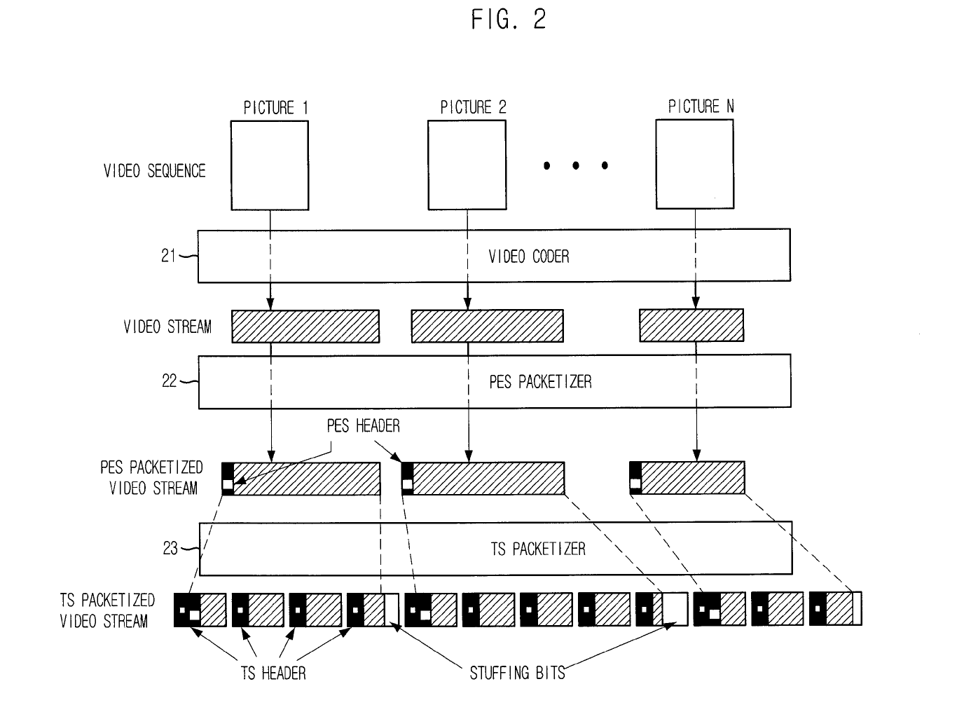

FIG. 3 is a block diagram showing a video coding apparatus controlling a video encoding rate based on the length of a Transport Stream (TS) packet in accordance with an embodiment of the present invention; and

FIG. 4 is a flowchart describing a video encoding rate controlling method based on the length of a TS packet in accordance with an embodiment of the present invention.

### BEST MODE FOR THE INVENTION

Other objects and advantages of the present invention will become apparent from the following description of the embodiments with reference to the accompanying drawings. Accordingly, those skilled in the art that the present invention is included can embody the technological concept and scope of the invention easily. In addition, if it is considered that detailed description on prior art may blur the points of the present invention, the detailed description will not be provided herein. The preferred embodiments of the present invention will be described in detail hereinafter with reference to the attached drawings.

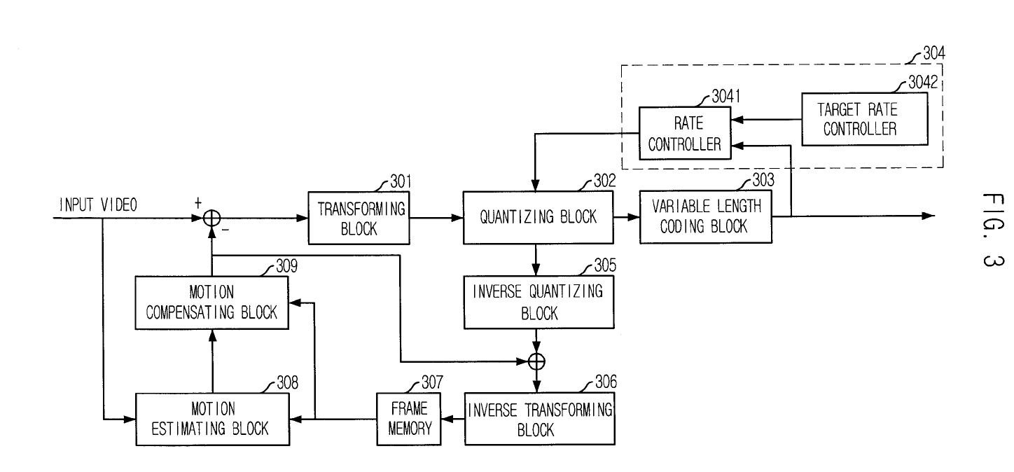

FIG. 3 is a block diagram showing a video coding apparatus controlling a video encoding rate based on the length of a Transport Stream (TS) packet in accordance with an embodiment of the present invention.

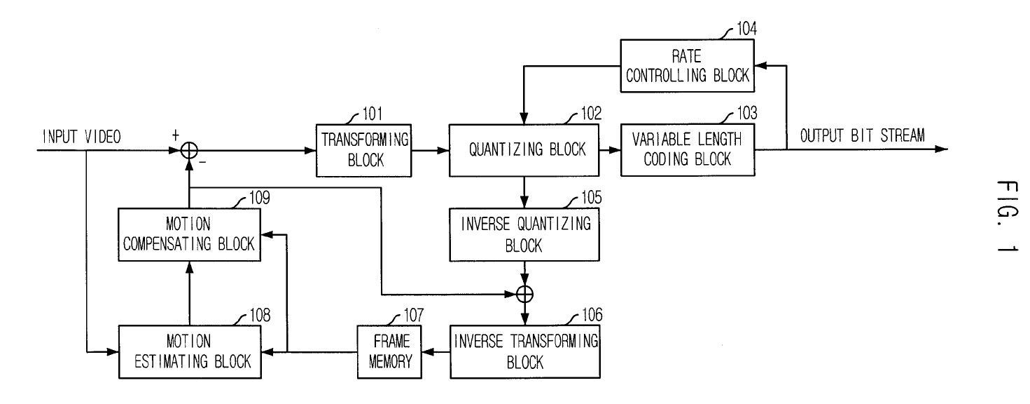

The video coding apparatus of the present invention includes a transforming block 301, a quantizing block 302, a variable length coding block 303, a rate controlling block 304, an inverse quantizing block 305, an inverse transforming block 306, a frame memory 307, a motion estimating block 308 and a motion compensating block 309. All the elements except the rate controlling block 304 are the same functions as the elements of the conventional video coder of FIG. 1.

The present invention relates to rate controlling which can minimize a bit waste caused by a difference between the length of an access unit and the length of a packet when a coded video stream is packetized. That is, the present invention controls the rate such that the length of the access unit becomes a multiple of the length of the TS packet based on the length of the TS packet in the video coding.

As shown in FIG. 3, the video coding apparatus of the present invention and a conventional video coder of FIG. 1 have a difference only in the rate controlling block 304.

Therefore, the video coding apparatus of the present invention can be divided into the video coding blocks and the rate controlling block 304. Herein, the video coding blocks transforms a difference between a present picture and a motion-compensated picture into a frequency domain, quantizes transform coefficient by control of a rate controlling means, performs a variable length coding on the transform coefficient and outputs the result into video bit stream. The video coding blocks include the transforming block 301, the quantizing block 302, the variable length coding block 303, the inverse quantizing block 305, the inverse transforming block 306, the frame memory 307, the motion estimating block 308 and the motion compensating block 309 for transforming a difference between a present picture and a motion-compensated picture into a frequency domain, quantizing transform coefficient by control of a rate controlling means, performing variable length coding on the transform coefficient and outputting video bit stream. The rate controlling block 304 controls the bit rate of the video coding means based on the length of the TS packet.

Meanwhile, the rate controlling block 304 includes a target rate controller 3042 for efficient rate controlling in addition to a conventional rate controller 3041.

Herein, the target rate controller 3042 obtains the number of packets required for packetizing a predetermined coded picture and a payload length, which can be used to packetize the coded picture except the number of bits required for header information and user data in each packet. The target rate controller 3042 also obtains an entire payload length, which is used for transporting and packetizing one coded picture by using the number of packets and the payload length in each packet. Subsequently, the target rate controller 3042 controls the target bit quantity to minimize the bit waste by the stuffing bits by using the entire payload length.

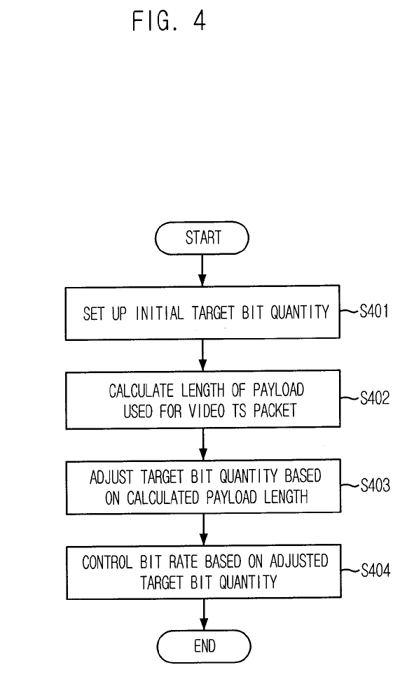

FIG. 4 is a flowchart describing a video encoding rate controlling method based on the length of a TS packet in accordance with an embodiment of the present invention. It shows a rate controlling process for one picture.

The present invention relates to rate controlling which can minimize a bit waste caused by a difference between a length of a coded video bit stream and a length of a transmission packet by controlling the rate of a video coder based on the length of the transmission packet, thereby improving an efficiency of the video coding. That is, in the rate controlling method of the present invention, a bit quantity allocated to a predetermined picture in coding of a video sequence is compared with the length of the TS packet and the target bit quantity is adjusted to minimize the bit waste caused by a difference between the bit quantity of the coded picture and the length of the TS packet. The rate is controlled to code the picture corresponding to the readjusted target bit quantity.

It will be described hereinafter with reference to FIG. 4.

At step S401, an initial target bit quantity of the picture to be coded is set up by using a typical video coding method, and at step S402, the length of a payload used to packetize the coded picture, which is an access unit or a video stream, into a TS packet, which is a TS packet, is calculated. That is, when one coded picture is packetized and a plurality of TS packets are generated, the length of the payload used for packetization is the same as the entire payload length adding up all the lengths of payloads of TS packets.

At step S403, the target bit quantity is adjusted by using the determined payload length to minimize the number of bits wasted by the stuffing bits. That is, the target bit quantity is adjusted upward or downward to fit to the length of the payload whose target bit quantity is calculated.

At step S404, the rate is controlled based on the adjusted target bit quantity. That is, a size of a quantization step is determined such that a coded result is not higher than the adjusted final target bit quantity.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

While the present invention has been described with respect to certain preferred embodiments, it will be apparent to those skilled in the art that various changes and modifications may be made without departing from the scope of the invention as defined in the following claims.

What is claimed is:

1. A method for controlling video encoding rate based on a length of a Transport Stream (TS) packet in a video coding apparatus, comprising the steps of:
a) setting up an initial target bit quantity for a picture to be coded;
b) calculating a length of a payload used to packetize a coded picture into TS packets;
c) adjusting the target bit quantity based on the length of the payload; and
d) controlling a rate based on the adjusted target bit quantity in the step c).

2. The method as recited in claim 1, wherein in the step b), the number of packets required for packetizing the coded picture, and a payload length which can be used to packetize the coded picture except the number of bits required for header information and user data in each packet are obtained, and an entire payload length which is used for packetizing one coded picture into TS packets based on the number of packets and the payload length in each packet is obtained.

3. The method as recited in claim 2, wherein in the step c), the target bit quantity is adjusted upward or downward such that the target bit quantity fits to the length of payload.

4. A video coding apparatus controlling rate based on a length of a Transport Stream (TS) packet, comprising:
a video coding means for transforming a difference between a present picture and a motion-compensated picture into a frequency domain, quantizing transform coefficient by control of a rate controlling means, performing a variable length coding on the transform coefficient and outputting the result into video bit stream; and
a rate controlling means for controlling the video coding means based on the length of the TS packet.

5. The apparatus as recited in claim 4, wherein the rate controlling means includes:
an initial target bit quantity setting means for setting up an initial target bit quantity for a picture to be coded;
a payload length calculating means for calculating a length of payload used to packetize the coded picture into TS packets;
a target bit quantity adjusting means for adjusting the target bit quantity based on the payload length; and
a rate controlling means for controlling a rate based on the adjusted target bit quantity in the step c).

6. The apparatus as recited in claim 5, wherein the payload length calculating means calculates the number of packets required for packetizing a coded picture and a payload length which can be used to packetize the coded picture except the number of bits required for header information and user data in each packet, and calculates an entire payload length which is used for transforming one coded picture into TS based on the number of packets and the payload length of each packet.

7. The apparatus as recited in claim 6, wherein the target bit quantity adjusting means adjusts the target bit quantity upward or downward such that the target bit quantity fits to the length of payload.
